(19) United States
(12) Patent Application Publication
(10) Pub. No.: US 2024/0109477 A1
(43) Pub. Date: Apr. 4, 2024

(54) BRAKE LIGHT FUNCTIONING SYSTEM AND METHOD EMPLOYED THEREOF

(71) Applicant: CHAITANYA BHAVARAJU, Vijayawada (IN)

(72) Inventor: CHAITANYA BHAVARAJU, Vijayawada (IN)

(21) Appl. No.: 18/206,656

(22) Filed: Jun. 7, 2023

(30) Foreign Application Priority Data
Sep. 29, 2022 (IN) IN 202241055927

(51) Int. Cl. B60Q 1/44

(52) U.S. Cl. CPC B60Q 1/441; B60Q 1/444

(57) ABSTRACT

Exemplary embodiments of the present disclosure are directed towards a brake light functioning system and method, comprising: one or more sensors configured to sense at least one of: first position; and second position of accelerator pedal, one or more sensors generates maximum voltage by detecting first position and minimum voltage by detecting second position of the accelerator pedal, the one or more sensors electrically coupled to a processing device, the processing device configured to read at least one of: the maximum voltage; and the minimum voltage generated by the one or more sensors, a relay electrically coupled to the processing device, the relay configured to turn on a brake light when the processing device detects the minimum voltage generated by the one or more sensors and turn off the brake light when the processing device detects other than minimum voltage generated by the one or more sensors.

### CROSS-REFERENCE TO RELATED APPLICATIONS

This patent application claims priority benefit of Indian Patent Application No: 202241055927, entitled “A BRAKE LIGHT FUNCTIONING SYSTEM AND METHOD EMPLOYED THEREOF”, filed on 29 Sep. 2022. The entire contents of the patent application are hereby incorporated by reference herein in its entirety.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present disclosure generally relates to the field of indicating a vehicle reduction in speed by activating the vehicle brake lights before actual braking takes place. More particularly, the present disclosure relates to a brake light functioning system and method employed thereof.

### BACKGROUND

The automobile plays a vital role in the modern developing world. In a country like India, this causes an increment in the rate of accidents. This rate is increasing daily, so it is necessary to take some preventive measures to avoid unwanted accidents. The number of road accident deaths per day is increasing daily, and the death rate is increasing per hour. Majorly Buses and Trucks contribute to road accident deaths. In addition, head-on collision hits from the back and hit and run are some of the classifications of accidents.

A great majority of automobile accidents involve rear-end collisions because a driver misjudging the rate at which a lead vehicle is slowing is the primary cause of rear-end collisions. A significant number of rear-end collisions may be avoided by appropriately warning other drivers of the vehicle's level of braking. Many brake light systems have been proposed to warn other drivers and reduce these collisions, and the existing systems' brake lights are activated when the driver applies force to the brake pedal. The brake lights convey to other drivers and individuals behind the vehicle that the driver is using the brakes. However, there may be situations where a vehicle slows down, but the driver does not engage the brake pedal. In these situations, the other driver of the following vehicle is not made aware of the slowing of the lead vehicle.

In the light of the aforementioned discussion, there exists a need for a certain system with novel methodologies that would overcome the above-mentioned disadvantages.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a brake light functioning system and method employed thereof.

An objective of the present disclosure is directed towards preventing the possibility of accidents due to rear end collisions.

Another objective of the present disclosure is directed towards indicating the reduction in the speed of the vehicle.

Another objective of the present disclosure is directed towards indicating the no acceleration phase of the vehicle when the vehicle is in idling condition.

Another objective of the present disclosure is directed towards turning on (glowing/activating) a brake light of a vehicle immediately after the release of an accelerator pedal.

Another objective of the present disclosure is directed towards turning off (deactivating) the brake light of the vehicle when the accelerator pedal is depressed.

Another objective of the present disclosure is directed towards the system that integrates into all kinds of vehicles.

Another objective of the present disclosure is directed towards the system that easily integrates with future technology vehicles to reduce accidents.

Another objective of the present disclosure is directed towards the system that easily incorporates into electric vehicles.

Another objective of the present disclosure is directed towards the system that easily integrates with the existing brake light systems.

Another objective of the present disclosure is directed towards providing a high value of TTC (Time-to-collision) indicating a lower chance of rear-end collisions.

Another objective of the present disclosure is directed towards the system that regulates the fuel supply to the engine.

According to an exemplary aspect, one or more sensors configured to sense at least one of: a first position; and a second position of an accelerator pedal, whereby the one or more sensors generates a maximum voltage by detecting the first position and a minimum voltage by detecting the second position of the accelerator pedal.

According to another exemplary aspect, the one or more sensors electrically coupled to a processing device, wherein the processing device configured to read at least one of: the maximum voltage; and the minimum voltage generated by the one or more sensors.

According to another exemplary aspect, a relay electrically coupled to the processing device, whereby the relay configured to turn on a brake light when the processing device detects the minimum voltage generated by the one or more sensors and turn off the brake light when the processing device detects the other than minimum voltage generated by the one or more sensors.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is an example block diagram depicting a schematic representation of a brake light functioning system, in accordance with one or more exemplary embodiments.

FIG. 2 is a circuit diagram depicting an embodiment of the brake light functioning system shown in FIG. 1, in accordance with one or more exemplary embodiments.

FIG. 3 is an embodiment of the brake light functioning system, in accordance with one or more exemplary embodiments.

FIG. 4 is a flowchart depicting an exemplary method for a brake light functioning system, in accordance with one or more exemplary embodiments.

FIG. 5 is a flowchart depicting an exemplary method for turning on and turning off a brake light, in accordance with one or more exemplary embodiments.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Referring to FIG. 1 is an example block diagram 100 depicting a schematic representation of a brake light functioning system, in accordance with one or more exemplary embodiments. The system 100 includes an accelerator pedal 102, a first sensor 104, a second sensor 106, a processing device 108, a relay 110, and a brake light 112.

The accelerator pedal 102 may be configured to allow the driver to accelerate the vehicle by depressing the accelerator pedal 102. The accelerator pedal 102 may include an electronic accelerator pedal. The accelerator pedal 102 may include the first sensor 104 and the second sensor 106. The first sensor 104 and the second sensor 106 may be configured to sense the positions of the accelerator pedal 102 and generates the voltages based on the positions of the accelerator pedal 102. The positions of the accelerator pedal 102 may include a first position and a second position. The first sensor 104 and the second sensor 106 may be configured to sense at least one of the first position and the second position of the accelerator pedal. The first position may include the process of depressing the accelerator pedal 102 and the second position may include the process of releasing the accelerator pedal 102. The first sensor 104 and the second sensor 106 may be configured to generate a maximum voltage when depressing the accelerator pedal 102. The first sensor 104 and the second sensor 106 may be configured to generate a minimum voltage when the accelerator pedal 102 releases. The first sensor 104 and the second sensor 106 may also be configured to generate a minimum voltage when the accelerator pedal 102 is not operated when vehicle in a stationary position. The first sensor 104 and the second sensor 106 may be electrically coupled with the processing device 108. The processing device 108 may be configured to read the position of the accelerator from the first sensor 104 and the second sensor 106. The processing device 108 may be configured to receive the voltage values from the first sensor 104 and the second sensor 106. The processing device 108 may be configured to read the at least one of the maximum voltage and the minimum voltage generated by the first sensor 104 and the second sensor 106. The relay 110 may be electrically coupled with the processing device 108. The relay 110 may be electrically coupled with the brake light 112 of the vehicle. The processing device 108 may be configured to trigger the relay 110 to turn on the brake light 112 of the vehicle when the processing device detects the minimum voltage generated by first sensor 104 and the second sensor 106. The processing device 108 may be configured to trigger the relay 110 to turn off the brake lights 112 of the vehicle when the processing device detects other than minimum voltage generated by the first sensor 104 and the second sensor 106.

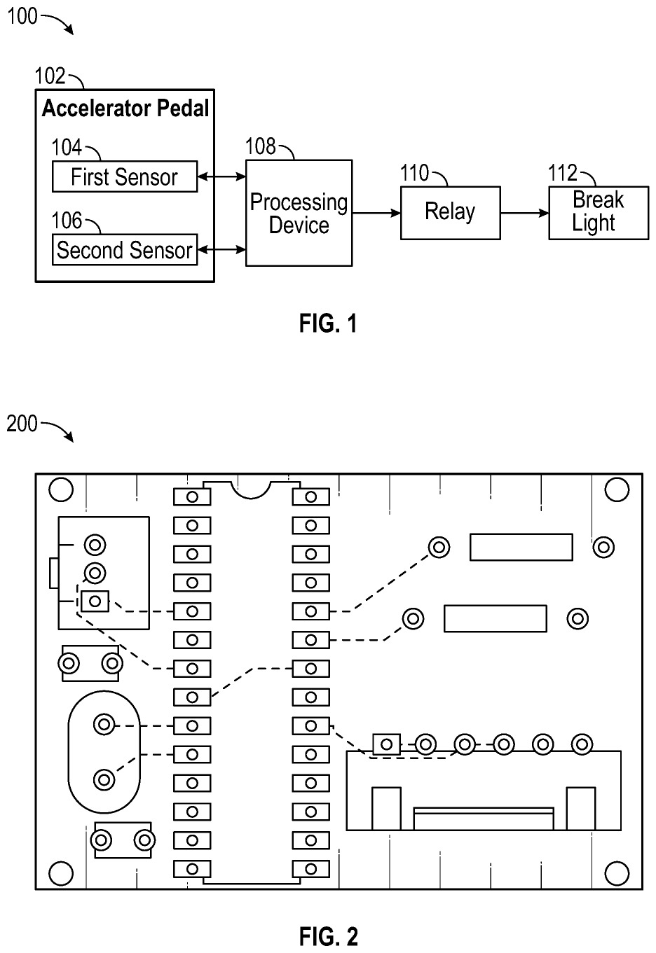

Referring to FIG. 2 is a circuit diagram 200 depicting an embodiment of the brake light functioning system shown in FIG. 1, in accordance with one or more exemplary embodiments. The first sensor 104 and the second sensor 106 may be configured to sense the positions of the accelerator pedal 102 and generates the voltages based on the positions of the accelerator pedal 102. The first sensor 104 and the second sensor 106 may be configured to sense at least one of a first position and a second position of the accelerator pedal. The first position may include the process of depressing the accelerator pedal 102 and the second position may include the process releasing the accelerator pedal 102. The first sensor 104 and the second sensor 106 may be configured to generate a maximum voltage when the accelerator pedal 102 depresses by the driver. The first sensor 104 and the second sensor 106 may be configured to generate a minimum voltage when the driver releases the accelerator pedal 102. The first sensor 104 and the second sensor 106 may also be configured to generate a minimum voltage when the accelerator pedal 102 is not operated by the driver when vehicle in a stationary position. The first sensor 104 and the second sensor 106 may be electrically coupled with the processing device 108. The processing device 108 may be configured to read the position of the accelerator from the first sensor 104 and the second sensor 106. The processing device 108 may be configured to receive the voltage values from the first sensor 104 and the second sensor 106. The processing device 108 may be configured to read the at least one of the maximum voltage and the minimum voltage generated by the first sensor 104 and the second sensor 106. The relay 110 may be electrically coupled with the processing device 108. The relay 110 may be electrically coupled with the brake light 112 of the vehicle. The processing device 108 may be configured to trigger the relay 110 to turn on the brake light 112 of the vehicle when the processing device detects the minimum voltage generated by first sensor 104 and the second sensor 106. The processing device 108 may be configured to trigger the relay 110 to turn off the brake lights 112 of the vehicle when the processing device detects other than minimum voltage generated by the first sensor 104 and the second sensor 106. The circuit 200 may include six input terminals and two output terminals. The six input terminals may be electrically coupled to the accelerator pedal 102 and the two output terminals may be electrically coupled to the brake light 112.

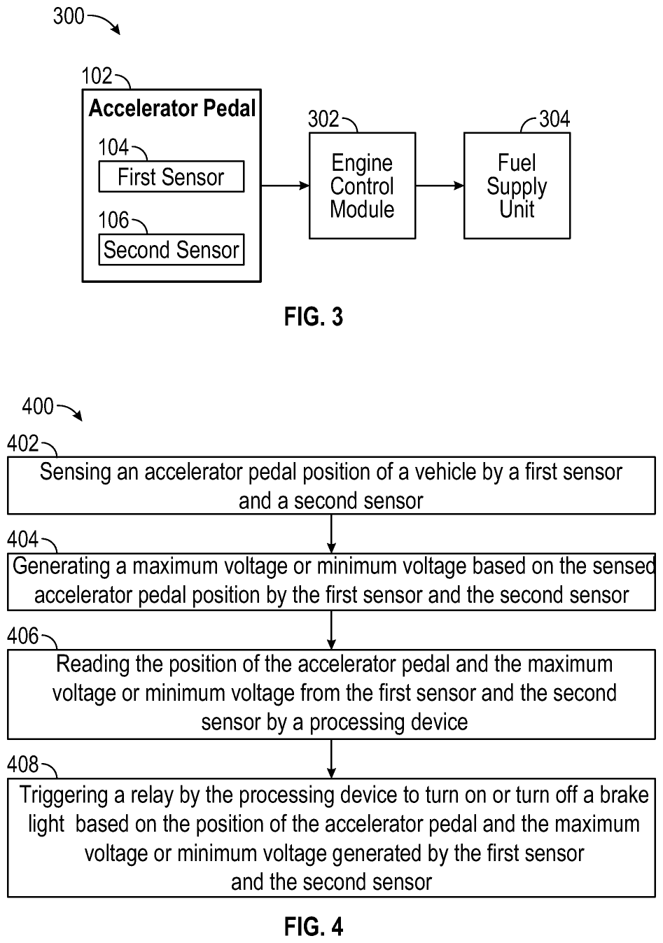

Referring to FIG. 3 is an embodiment of the brake light functioning system, in accordance with one or more exemplary embodiments. The system 300 includes an accelerator pedal 102, a first sensor 104, a second sensor 106, an engine control module 302, and a fuel supply unit 304.

The accelerator pedal 102 may be configured to connect to the engine control module 302. The first sensor 104 and the second sensor 106 may be configured to sense at least one of a first position and a second position of the accelerator pedal. The first sensor 104 and the second sensor 106 may be configured to generate a maximum voltage when the accelerator pedal 102 depresses by the driver. The first sensor 104 and the second sensor 106 may be configured to generate a minimum voltage when the driver releases the accelerator pedal 102. The first sensor 104 and the second sensor 106 may also be configured to generate a minimum voltage when the accelerator pedal 102 is not operated by the driver when vehicle in a stationary position. The first sensor 104 and the second sensor 106 may be configured to send the generated the maximum voltage and the minimum voltage to the engine control module 302. The engine control module 302 may be configured to regulate the fuel supply to the engine through the fuel supply unit 304 based on the voltage values. The engine control module 302 may be configured to increase the fuel supply to the engine of the vehicle when the engine control module 302 receives the maximum voltage from the first sensor 104 and the second sensor 106. The engine control module 302 may be configured to stop the acceleration process when the engine needs to start the braking action.

FIG. 4 is a flowchart 400 depicting an exemplary method for a brake light functioning system, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, sensing the accelerator pedal position of the vehicle by the first sensor and the second sensor. Thereafter at step 404, generating the maximum voltage or the minimum voltage based on the sensed accelerator pedal position by the first sensor and the second sensor. Thereafter at step 406, reading the position of the accelerator pedal and the maximum voltage or the minimum voltage from the first sensor and the second sensor by the processing device. Thereafter at step 408, triggering the relay by the processing device to turn on or turn off the brake light based on the position of the accelerator pedal and the maximum voltage or minimum voltage generated by the first sensor and the second sensor.

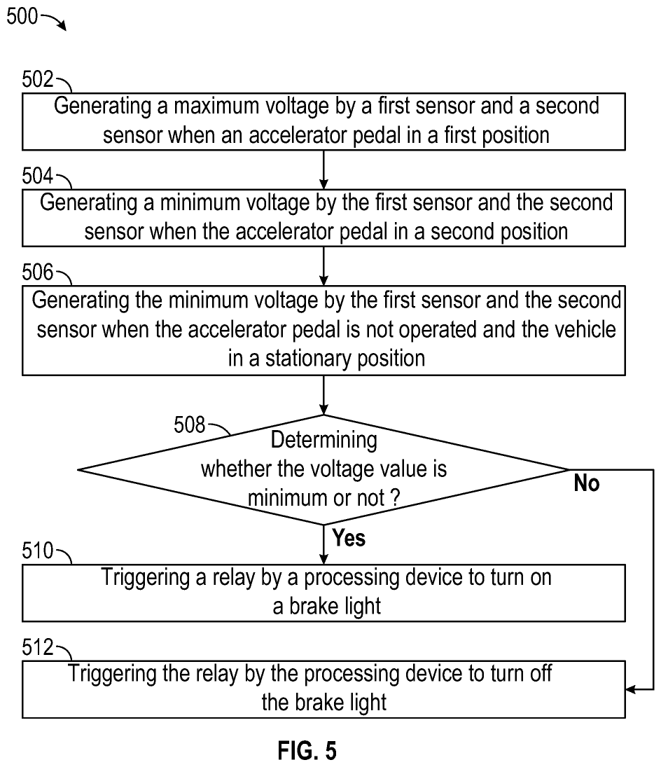

FIG. 5 is a flowchart depicting an exemplary method for turning on and turning off a brake light, in accordance with one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The method commences at step 502, generating the maximum voltage by the first sensor and the second sensor when the accelerator pedal in the first position. Thereafter at step 504, generating the minimum voltage by the first sensor and the second sensor when the accelerator pedal in the second position. Thereafter at step 506, generating the minimum voltage by the first sensor and the second sensor when the accelerator pedal is not operated and the vehicle in a stationary position. Determining whether the voltage value is minimum or not, at step 508. If answer at step 508 is Yes, the method continues at step 510, triggering the relay by the processing device to turn on the brake light. If answer at step 508 is No, the method continues at step 512 triggering the relay by the processing device to turn off the brake light.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A brake light functioning system, comprising:
one or more sensors configured to sense at least one of: a first position; and a second position of an accelerator pedal, whereby the one or more sensors generates a maximum voltage by detecting the first position and a minimum voltage by detecting the second position of the accelerator pedal;
the one or more sensors electrically coupled to a processing device, wherein the processing device configured to read at least one of: the maximum voltage; and the minimum voltage generated by the one or more sensors; and
a relay electrically coupled to the processing device, whereby the relay configured to turn on a brake light when the processing device detects the minimum voltage generated by the one or more sensors and turn off the brake light when the processing device detects the other than minimum voltage generated by the one or more sensors.

2. The system as claimed in claim 1, wherein the one or more sensors configured to generate the minimum voltage when the accelerator pedal is not operated and a vehicle in a stationary position.

3. The system as claimed in claim 2, wherein the processing device configured to trigger the relay to turn on the brake light when the processing device detects the minimum voltage generated by the one or more sensors.

4. The system as claimed in claim 1, wherein the first position of the accelerator pedal comprises a process of depressing the accelerator pedal.

5. The system as claimed in claim 1, wherein the second position of the accelerator pedal comprises a process of releasing the accelerator pedal.

6. The system as claimed in claim 1, wherein the accelerator pedal is electrically coupled with an engine control module and the engine control module configured to regulate the fuel supply to the engine from a fuel supply unit.

7. The system as claimed in claim 1, wherein the one or more sensors configured to send the generated the maximum voltage and the minimum voltage to the engine control module.

8. The system as claimed in claim 6, wherein the engine control module is configured to increase the fuel supply to the engine when the engine control module receives the maximum voltage from the first sensor and the second sensor.

9. The system as claimed in claim 6, wherein the engine control module is configured to limit the fuel supply to the engine when the engine control module receives the minimum voltage from the first sensor and the second sensor.

10. A brake light functioning method, comprising:
generating a maximum voltage by a first sensor and a second sensor when an accelerator pedal in a first position;
generating a minimum voltage by the first sensor and the second sensor when the accelerator pedal in a second position;
generating the minimum voltage by the first sensor and the second sensor when the accelerator pedal is not operated and a vehicle in a stationary position;
reading at least one of: the maximum voltage; and the minimum voltage generated by the one or more sensors by a processing device;
triggering a relay by the processing device to turn on a brake light when the processing device detects the minimum voltage; and
triggering the relay by the processing device to turn off the brake light when the processing device detects other than minimum voltage.
